(19) United States
(12) Patent Application Publication
(10) Pub. No.: US 2016/0005273 A1
(43) Pub. Date: Jan. 7, 2016

(54) CARD DECK AND GAMES

(71) Applicant: Peter Costa, Las Vegas, NV (US)

(72) Inventor: Peter Costa, Las Vegas, NV (US)

(21) Appl. No.: 14/789,982

(22) Filed: Jul. 1, 2015

Related U.S. Application Data
(60) Provisional application No. 62/019,615, filed on Jul. 1, 2014.
(60) Provisional application No. 62/035,933, filed on Aug. 11, 2014.

(51) Int. Cl. G07F 17/32; A63F 1/00

(52) U.S. Cl. CPC G07F 17/3293; A63F 1/00; G07F 17/3244

(57) ABSTRACT

Card games that can use a traditional deck or a custom card deck. The custom card deck disclosed herein is made up of 48 cards. There are two suits and eight sets of six cards numbered ace through six. The card deck can be used for unique games or for games that typically use dice. Example games that can be played with this deck are provided. Additionally, the disclosure describes various tournament rules that can be used for some of the disclosed games

### CROSS-REFERENCE TO RELATED APPLICATIONS

This application claims the benefit of U.S. Provisional Patent Application Ser. No. 62/019,615, filed on Jul. 1, 2014, titled CARD DECK AND GAMES, and claims the benefit of U.S. Provisional Patent Application Ser. No. 62/035,933, filed on Aug. 11, 2014, titled GAMES, CARD DECKS, AND TOURNAMENT RULES.

### BACKGROUND OF THE INVENTION

Card games are typically played using a 52-card deck of playing cards. These cards are often made of a heavy glossy paper or plastic material. The front surface of the card includes printed indicia thereon that distinguish the cards from each other. The rear surfaces of the cards are blank or include a decorative design or pattern. The rear surface is typically the same on all cards so that one card cannot be distinguished form another card by viewing the rear surface. Various card games can be played using this standard deck of cards. Card games are often now played in an electronic format online or utilizing an electronic gaming cabinet or video poker type machine.

A variety of different card games exist. Some card games involve gambling. An example of a gambling card game is blackjack, in which players bet into a pool, called the pot. Each player receives two cards with the option to receive one or more cards. After betting has been completed, players compare their hands with each other to determine the winner. The pot is awarded to the winner.

Dice games are typically played using two or more dice. These dice are often made of a plastic material and are six-sided cubes. Each side of the dice is labeled with a number (one, two, three, four, five, or six) with each number being represented once per die. A variety of difference dice games exist. Some dice games involve gambling. An example of a dice game is backgammon.

### SUMMARY OF THE INVENTION

Generally, the disclosed invention is related to games that can use a traditional deck, in some embodiments, a custom card deck, or no deck of cards. The custom card deck disclosed herein is made up of 48 cards. There are two suits and eight sets of six cards numbered ace through six. The card deck can be used for unique games or for games that typically use dice. Example games that can be played with this deck are provided. Additionally, the disclosure describes various tournament rules that can be used for some of the disclosed games.

### BRIEF DESCRIPTION OF THE DRAWINGS

FIG. 1 is a schematic block diagram of an example deck of playing cards.

FIG. 2 is a schematic block diagram of several playing cards arranged on a table during play.

FIG. 3 is a schematic block diagram depicting an example computing system used with one embodiment of the present invention.

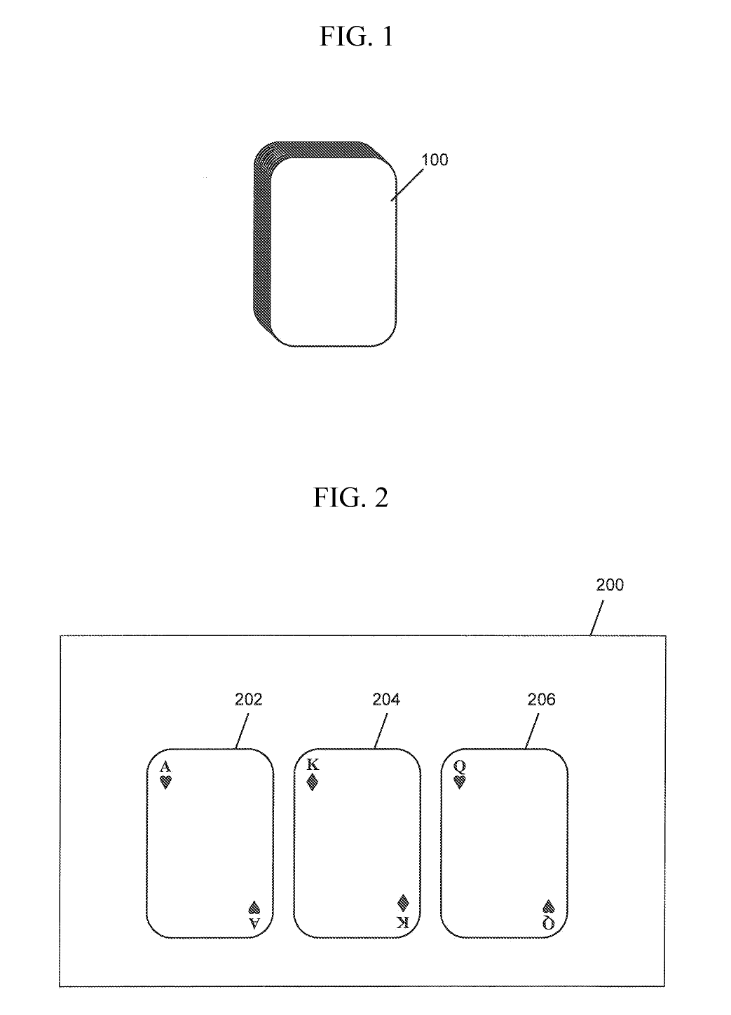

### DETAILED DESCRIPTION

Various embodiments will be described in detail. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

### Custom Card Deck Games

The following games can utilize a custom deck or multiple custom decks. Each deck includes 48 cards. The cards are made up of two suits, circles and squares, and 8 sets of ace through six, with ace equating to one. Of these, four sets of ace through six can form one suit (circles) and four sets of ace through six can form another suit (squares). This dice deck not only allows for a variety of unique games, but can also be used to replace dice rolls in games for which dice are used to determine a player's turn to move.

1. Board Games

1.1 Card-Gammon

The game of backgammon can be played to various levels of skill by introducing the disclosed dice deck to backgammon and eradicating the use of dice. In some embodiments, players may have the option to play with each player's card hidden from their opponent. In other embodiment, players may have the option to play with all cards face open.

In some embodiments, players can be dealt more than two cards at a time. Specifically, players can be dealt a predetermined number of cards from two upwards. From these, players use two cards per turn to move their pieces. The more cards that are dealt to players, the higher the required skill level.

In one embodiment, six cards are dealt to each player. The players can then rearrange their six cards in any way they choose to make three sets of two cards, in effect, giving the players their three next moves. This would allow a more skillful strategy to be applied to the traditional game of backgammon. Once players have used all of the cards in their hands, a further six cards are dealt to each player. This type of play and dealing continues until one player has won and the game is over.

To begin, players can choose cards in turn from a random selection. In the above example, 12 cards will be randomly selected from the deck of 48. Players then take turns choosing one card until each player has chosen six cards. Since there is an advantage to the player choosing first, the player choosing second would be first to play. This process is repeated after every turn.

In regards to doubles, in some embodiments, only cards of the same suit would count as a double move. Therefore, a player holding two cards of the same number (for example, six, six) may move two pieces if the two cards are of separate suits (for example, a circle and a square). If the two cards are of the same number and suit (for example, a six circle and a six circle), the player may move four pieces. This rule will require strategy from players if players choose their six cards from the twelve options.

In some embodiments, a traditional backgammon doubling cube could come into play before each new deal of cards to speed up match play, provide an added dimension for strategy, and keep track of the increase in stakes of the game.

Another option is for players to be dealt four cards initially. Players can choose two of the four cards in their hands for their first move and then draw two more before their next move. This process can continue until a winner is determined.

Another option is for players to be dealt three cards each turn. Players then choose two of the three cards in their hands for their move. In one embodiment, players can keep one card and then draw two more. In another embodiment, players can play two cards, discard the remaining card, and draw three more cards for their next turn. This process continues until the game is over.

The overall effect is that backgammon is played to its exact rules, apart from cards replacing dice rolls in a number of different formats.

2.2 Monopoly and Other Board Games

The above method could apply to the game of Monopoly and other board games. In the case of Monopoly, the game can be transformed by offering a more skillful version to players. Again, the more cards dealt to players, the higher level of skill.

More randomness could be introduced by having an odd number of cards dealt to the players. If five cards are dealt instead of six, players will need to draw one more card in order to complete their third move. The same format could be used for backgammon used with the dice deck.

2. Felt/Casino Games

2.1 Turbo/Speed Poker 3 (TP3)

TP3 has one enforced wager called an ante and an optional wager on the Points Plus wager. After being dealt three cards to each player and the dealer, the player has the option to fold and lose the ante wager or play by matching the ante wager. It is then a showdown between the player and dealer with the best hand winning.

For the dealer to qualify, a minimum poker hand must be achieved. For example, the dealer must have at least Ace-Five high from the three cards. If the dealer does not, the player is paid one for one on the ante only. The play wager is returned.

The Points Plus wager is based solely on the players' three cards and will pay according to a selected pay table. This is an example table.

Trips=10:1

Straight Flush=3:1

Straight=3:2

Flush=1:1

All others lose

House edge 4.26%

2.2 Poker-Jack11

In this game, each player can place two matching wagers in a showdown versus the dealer. One wager is for a blackjack hand closest to eleven. The second wager is on a two-card poker hand. Players and the dealer are dealt three cards from the disclosed dice deck. Players can then choose two of the three cards that will combine the best poker hand and the best blackjack hand. The remaining card is discarded.

The dealer can prioritize the best blackjack hand on a total of seven or eight depending on the final math. If the dealer cannot reach that mark, the dealer prioritizes the best poker hand. An optional wager for the player is for the three cards to pay according to a pay table.

One possible pay table would offer the following payouts.

Trips=10:1

Straight Flush=3:1

Straight=3:2

Flush=1:1

All others lose

House edge 4.26%

2.3 Holdem 5/Texas 5

This is a multi-player poker version for either tournaments or cash games. Two cards are dealt to each player, which are then used to create the best five-card poker hand by combining three community cards. By using the disclosed dice deck, it offers a variety of options in how the betting structure is applied. The more betting options, the more skill applied.

2.3.1 Version One

In this version, all players ante before being dealt their two cards. Players then have one simple option: to either double the wager and stay in play or to fold. Each player will need to consider the following in making their decision.

Once all wagers have been made, players will reveal their two cards and a community flop is dealt that includes three cards. The best hand will win all wagers. Players will be risking more than their original wager, because bonuses will be paid to the winner depending on the ranking of the winning hand.

With this dice deck containing eight of each card, the biggest bonus may be paid on five-of a-kind, followed by a number of other high ranking hands such as a straight flush, four-of-a kind, straight, flush, and three-of-a-kind. Players will, therefore, need to be selective and play hands that are more likely to make a high-ranking hand. For example, any pair, any suited two cards, or any two straight cards.

2.3.2 Version Two

By not including the bonus payouts, and by introducing rounds of betting, Texas 5 could be played to the standard holdem format. A number of options are offered and they include one, two, three, or four rounds of betting. This number would be dependent on how many community cards are dealt on the flop. This could range between one and three.

2.3.3 Version Three

Due to having double the number of cards represented, (for example, eight aces instead of four), the betting structure may be adjusted in order to find the perfect format. One way is to limit the size of the wager. Another is for players to make a single wager based on their starting hand.

2.3.4 Version Four

Holdem 5 is ideal as a player versus electronic on a video poker cabinet. The dealer would play to a fixed strategy in terms of when to raise, call, or fold. Apart from a showdown between the player and the dealer, bonuses could be paid on the ranking of the five-card poker. The player would therefore have an option as to the stakes for the showdown and the size of the bonuses.

2.4 Joker Poker 5

Players can place an ante wager and are dealt two cards face up from the disclosed dice deck. In some embodiments, a single deck can be used. In other embodiments, multiple decks can be used. Based on the two dealt cards, players must decide to either play by matching the ante wager or to fold and lose the ante wager.

The object of the game is to create the best five-card poker hand by being dealt a further two cards and by using a mythical joker. It is then a showdown between the player and the dealer with the best five-card poker winning.

In order for the showdown to take place, the dealer must, in some embodiments, qualify with a minimum hand. This can be dependent on the final math but it will be three-of-a-kind. For example, 3-3-3. If the dealer fails to qualify, the players win one for one on the ante and the play wager is returned.

An optional wager can be offered to players. The optional wager should be placed prior to any cards being dealt. Payouts should be based on the players' first two cards. Winnings can be paid according to the Points Plus paytable below.

Points+side bet pays on any two-card straight flush or a total of 10 or more. All cards count as face value.

Total of 12=10:1

Total of 11=5:1 if it is 6-5 suited, 2:1 otherwise

Total of 10=3:2

Other straight flushes (A-2, 2-3, 3-4, 4-5 suited)=1:1

All others lose

Points+optional pay table

This pay table would again be based on the player's first two cards and would pay on pairs, suited pairs, and two-card straight flushes.

2.5 Joker Poker 4

To start, players place an ante and are dealt two cards face up from the disclosed dice deck. A single deck or multiple decks can be used. Based on the two dealt cards, players must decide to either play by matching the ante wager or to fold and lose the ante wager.

The object of the game is to create the best four-card poker hand by being dealt a further one card and by using a mythical joker. It is then a showdown between the player and the dealer with the best four-card poker winning.

In order for the showdown to take place, in some embodiments, the dealer must qualify with a minimum hand. This may be dependent on the final math (for example, Aces plus). If the dealer fails to qualify, the players win one for one on the ante and the play wager is returned.

An optional wager can be offered to players. If offered, it should be placed prior to any cards being dealt. Payouts can be based on the player's first two cards. Winnings can be paid according to the Points Plus pay table below.

Points+side bet pays on any two-card straight flush or a total of 10 or more. Cards count at face value with Ace equal to one.

Total of 12=10:1

Total of 11=5:1 if it is 6-5 suited, 2:1 otherwise

Total of 10=3:2

Straight flushes (A-2, 2-3, 3-4, 4-5 suited)=1:1

All others lose

Points+optional pay table

This pay table would again be based on the player's first two cards and would pay on pairs, suited pairs, and two-card straight flushes.

2.6 Holdem 4

Holdem 4 is ideal as a player versus electronic on a video poker cabinet. The dealer would play to a fixed strategy in terms of when raise, call, or fold. Apart from a showdown between player and dealer, bonuses would be paid on the ranking of the five-card poker. The player would, therefore, have an option as to the stakes for the showdown and the size of the bonuses.

2.7 Joker Poker 2

The object is to create the best possible poker hand of three cards, in which one is a mythical joker. Players place an ante and are dealt two cards from the disclosed dice deck, face up. The dealer is dealt two cards face down.

Players are then faced with the option to fold and, therefore, lose the ante wager or to play by making a further wager. The size of the second wager is dependent on the final math, but could range between 1× the ante to as much as 20× times the ante.

If a player plays and makes the second wager, it is then a showdown between the player and the dealer with the best hand winning. Winning wagers are paid one for one. The ranking of hands from best to worst can be, but is not limited to, (1) three-of-a-kind; (2) straight flush; (3) straight; (4) flush; (5) pair.

Strategy for the player is fairly simple as there are, in effect, six hands where players are advised to fold. These are two-card hands that are not connected to form a straight when the joker is added (an Ace with a 4, 5, or 6; a Deuce with a 5 or 6; a 3 with a 6).

A suited Ace with 5 or Ace with 6 may just about be playable. A small straight (A-2-3 or 2-3-4) is certainly playable, but not a strong hand. The strongest hands are any pairs with Aces being the highest followed by 6-6, 5-5, 4-4, 3-3, 2-2. These are followed by all straight flushes and then by high straights.

Points+side wager.

An optional wager can be offered to players. The wager should be placed prior to any cards being dealt. Payouts should be based on the players' first two cards. Winnings can be paid according to the Points+pay table.

Points+side bet pays on any two-card straight flush or a total of 10 or more. Cards count at face value.

Total of 12=10:1

Total of 11=5:1 if it is 6-5 suited, 2:1 otherwise

Total of 10=3:2

Straight flushes (A-2, 2-3, 3-4, 4-5 suited)=1:1

All others lose

Points+optional pay table

This pay table would again be based on the player's first two cards and would pay on pairs, suited pairs, and two-card straight flushes.

2.8 Joker Poker 2 (No Ante)

In this version, there are no antes but players can double down on their initial wager. Players can place a wager and can be dealt one card face up. The dealer can be dealt one card face down. Based on their first card, players can match their initial wager by doubling down. Irrespective, players would then be dealt a second card face open and the dealer a second card face down. A showdown then takes place with the best three-card hand winning. The three cards in this case consist of a player's two cards, a dealer's two cards, and a mythical joker.

Doubling down is the most important aspect of the game, and players are advised of the following: from the six possible cards of Ace, Deuce, Three, Four, Five or Six, players are advised to always double down on a Three or a Four and Five as the odds of creating a strong hand favor the player.

With a Three, a player would make a straight with a 2, 4, 5 and a straight flush if both cards were of the same suit. They would also make three-of-a-kind with another Three.

With a Four, players would make a straight with a 2, 3, 5, 6 (a straight flush if both cards are suited), and three-of-a-kind with another Four. In effect, Four is the prime card for creating a strong hand, as only an ace is not beneficial.

With a Five, players create a strong hand with a 3, 4, 5, 6.

It is important to note that an Ace on the first card limits the opportunity to create a strong hand. However, a player being dealt Ace-Ace would have an unbeatable hand. With this in mind, players being dealt an Ace on the first card are able to double down for a bonus payout if their hand wins the showdown.

Ace with a second Ace is not only unbeatable but would pay (dependent on the final math), 2 for 1. Ace with a suited second Ace, would pay 3 for 1. The bonus payout may pay 2-1 on any winning showdown. This includes a straight or straight flush.

Points+side wager.

An optional wager can be offered to players. This optional wager should be placed prior to any cards being dealt. The payout should be based on the player's first two cards. Winnings can be paid according to the Points+pay table.

Points+side bet pays on any two-card straight flush or a total of 10 or more. Cards count at face value.

Total of 12=10:1

Total of 11=5:1 if it is 6-5 suited, 2:1 otherwise

Total of 10=3:2

Straight flushes (A-2, 2-3, 3-4, 4-5 suited)=1:1

All others lose

Points+optional pay table

This pay table would again be based on the player's first two cards and would pay on pairs, suited pairs, and two-card straight flushes.

2.9 One-Card-Poker

While One-Card-Poker can be played with a traditional deck, as described below, this version uses the custom deck described above, wherein the Six is high and Ace is low.

Players have the option to wager on any of six possible wagering cards prior to the dealer dealing four cards face up. The four face up cards are known as the community board. The community board is added to by one of the six wagering cards that would combine with the community to create the best possible five-card poker hand.

It is important to note that each wagering card represents both suits and colors. For example, when the board has four cards to a possible straight or four cards to a possible flush, the straight or flush would be completed by using the missing card from one of the six wagering cards. For example, if the community board is comprised of 2, 3, 4, and 5, the six from the wagering cards will be added to complete the best possible five-card hand.

The same applies for a board of four cards to a flush. Therefore, for any community board with four cards of the same suit, the six of that suit would be added to form the flush. This is irrespective if a six of the same suit forms part of the community board. This will be a fairly regular occurrence due to each card being represented four times in each deck.

Wagering cards will offer different payouts with an Ace offering the highest odds and a Six offering the lowest odds. The pay table will be dependent on the final math. The following is an example pay table:

Ace pays 12:1

Deuce pays 10:1

Three pays 8:1

Four pays 7:1

Five pays 5:1

Six pays 4:1

All odds may pay higher or lower based on the final math.

Optional wagering options may include Yo Exacta and Bonus Five. The Yo Exacta wager refers to predicting that a Six and a Five from the wagering cards, would form the best two possible five-card hands. For example, in the case of flushes, the Six will be determined as the best hand and the Five would be determined as the second best. In such cases, the Yo Exacta wager would win. The possible payout for this would be determined by the final math.

The Bonus Five wager offers a pay table based on the rank of the winning hand. This will range between three-of kind and five of a kind of the same suit. Below is an example pay table.

Three-of-a-kind of the same suit pays 2:1

Straight pays 4:1

Flush pays 5:1

Five-of-a-kind or straight flush pays 10:1

Five-of-a-kind of the same suit pays 40:1

This pay table is an example and payouts maybe higher or lower and include of possible five-card hands.

2.10 One-Card Texas Holdem

Each player is dealt two cards before a round of betting takes place. A community board of two cards is the dealt and another round of betting follows. The third community card is then dealt and a round of betting follows. A fourth and final community card is dealt is followed by a final round betting. Each player must use one of their two cards and combine it with the four community cards to form the best five-card poker hand.

2.11 Lucky Colors

Lucky Colors uses a custom deck of cards that is comprised of two suits, circles and squares and two colors, red and black. There are eight sets of six cards, a set comprised of six cards of ace through to six. A single deck or multiple decks can be sued.

Players will have one compulsory wager and two optional wagers. A compulsory wager is made before each player is dealt two cards, one card at a time. These are dealt face open and are placed in sequence. A player will win the wager if the two cards are of a different color, one read and one black.

When a player has won, the player then has an option to continue or take the winnings. A player may continue by leaving the original wager or the original wager and the winnings and continue by being dealt another card face up. The object is for the player to be dealt an opposite color to the preceding card. For example, if a player has been dealt a red card and then a black card, if order to win the next wager, the next card must be red.

A player can continue after every winning wager until the player either decides to take the winnings or when the player loses.

Optional Wagers

(1) Players place a wager that is based on the number of wins accumulated in one hand. The pay table will vary and be dependent on the final math. As an example, winning three hands would pay 2 for 1. Four winning hands would pay 4 for 1. Five winnings hands would pay 6 for 1 and so on. Depending on the final math, the pay table may pay up to ten winning hands or more and would pay 100 for 1. This side wager only comes into play if the original wager is a winning wager. If the player decides to stop and take the winnings at any time, this side wager will continue and the player is dealt further cards until the winning sequence is broken. The winning hands are counted and the player is paid according to the pay table

(2) A pay table is offered based on the point's value and or poker value on the player's first two cards.

2.12 Five Card Texas Player Versus Computer (Dealer)

The custom deck comprises of two colors, red and black and two suits, circles and squares, and eight sets of six cards from ace through to six, with four sets of each suit and color.

Two cards each are dealt to player and dealer. These are then used in connection with a flop or board of three cards to form a five-card poker hand. The player and dealer post an ante and the player or dealer has the option to call a predetermined wager or raise to a predetermined wager. If the player chooses to play, then the player must then decide if the bonus payout will apply to the hand and the amount of the bonus.

This bonus is determined by the ranking of the five-card poker hand and is liable by the player and by dealer. The card ranking of this custom deck is based on face value. Therefore, six is high and ace is low.

The dealer will call, raise or fold under a set criteria based on the dealer's two cards. This will be determined by the final math. For example, the dealer will fold certain hands such as any ace not suited or connected and will raise with high ranking hands such as 6-5 suited, pairs, and suited connected cards. The player will be advised to follow the same strategy.

The following bonus payout table is an example and will be determined by the final math. Five-of-a-kind suited, five-of-a-kind, straight flush, four-of-a-kind suited, four-of-a-kind, full house, straight, flush, three-of-a-kind suited, three-of-a-kind. The amount payable or paid out would be determined on the final math. The bonus is an optional wager. The original wager is a shootout between player and dealer with best hand winning.

### Traditional Card Deck Games

### 1. Fantasy Poker Tournaments (FPT)

FPT is a method of presenting a fantasy tournament in which the generated prize pool or prize pool will be distributed to winning entrants based on the result of an actual online tournament. FPT will, in effect, allow an online gaming operation to offer a form of staking or backing of players playing in a poker tournament. The staking or backing of players is not only a part of poker, but has, in recent years, grown with a number of operations now offering a staking service.

The staking of a player would normally see a variety of returns to the backer. For example, a backer may pay 100% of player's entry fee into a tournament. In return, the backer may seek a percentage of any winning returns. In some cases, this percentage can be as little as 40%, rising to 70% or even 80%. FPT can allow a backer to stake players for 100% of returns.

It's important to note that FTP will not require interaction or any agreement for one player to stake another. Also, the operator may distribute winnings to all players as is standard with any online tournaments.

By offering FPT, not only would an operator dramatically increase revenue, it could attract those simply looking to invest in the performance of another player. It is, therefore, important that a player's current form be made available. For example, a player's last twenty tournament results may be easily accessible to a potential FPT player. This would allow FPT players to use their skill and judgment in choosing a player to stake.

The following examples show how an operation may implement FPT.

An online tournament has an entry stake of $100. Players registering in this event will be offered a variety of fantasy events. In this example, there are four fantasy tournaments (this number may be lower or higher) with different entry stakes: $100, $50, $25 and $10 (entry stakes may be a different amount in another example). Players looking to enter a fantasy event, therefore, may wish to enter any or all four of the fantasy events. Entry can be offered on a first come, first served basis.

This would, therefore, create five different tournaments and five different prize pools, as the number of entries for each tournament may vary. For example, the real, live, online tournament may have 1,000 players. The $100 fantasy may have 200 players and the $50 may have 250 players. Irrespective, a “staked” player would only need to beat the other players within the selected fantasy tournament.

For example, a player has staked player “A” in the $100 fantasy tournament. That player may, in effect, win the fantasy tournament for the backer and still only place 251^{st} in the online tournament if, of course, none of the 250 players placed above have been staked in the $100 fantasy tournament.

Another option is to first offer the fantasy tournaments to the player playing in the online event. If that player declines any of the four fantasy tournaments, that player would be made available for another to stake. In effect, one online tournament could generate multiple entry fees for the operator and, as such, increase revenue.

Another option is to allow players to form their own fantasy prize tournament and prize pool. This could be limited to friends or to a certain number of fantasy players. In fact, as long as two players take part in a fantasy tournament, then it would still create extra revenue.

FPT should be offered across the board to include any and all tournaments. In effect, the operator would be offering players a service that is widely common and very much enjoyed.

Apart from attracting “investors” or “backers,” the operator can offer the less-skilled players an opportunity to invest in proven players. Just as importantly, time constraints may never be a factor. As such, players may make their investments and not be actively engaged in the game. Either way, FPT offers a unique and marketable feature, which will be very much appreciated and enjoyed by the vast majority of players.

Rules

1. Players entering an online tournament will have the first option to enter any of the fantasy tournaments on offer, be they one, two, three, or more. Any fantasy tournaments not entered by the player will be open to any other player.

2. Players may choose more than one player to stake if a fantasy tournament is open.

3. Players may form their own fantasy tournaments by selecting an entry fee. This may be open to all players or to invited players only and with or without a maximum number of entries.

### 2. Push Poker (all-in or Fold)

Push Poker tournaments require players to make one of two decisions, to go all-in with their stack or fold. Each decision is based on either the player's poker hand or the situation during the tournament.

Rules

Players will have a pre-determined number of hands in which they must go all-in. In one example, players will have ten hands. However, this number may be higher or lower. On the tenth hand, if a player has not gone all-in, it will be a compulsory all-in.

Players may also have a pre-determined number of lives for a tournament. In one example, a player may have three lives (though this may be higher or lower). If a player busts, they simply lose a life and remain in the tournament until all lives are lost.

When a player has lost and a life has been lost, the player will return to the tournament with an average starting stack. This will be the case even when there are just two players remaining. For example, if a player has busted, but still has a life remaining, that player will return to the game with the exact amount of the opponent. It is, therefore, important for players to retain as many lives as possible.

A counter will be displayed and will count down the remaining number of hands until a player will face a compulsory all-in. Once a player has gone all-in and has chips returned, the counter will revert to the pre-determined number of hands. The same applies when a player has busted and has used a life to return to the tournament.

Although several skills of poker will be eradicated, it will require skill and good strategy by players as to when to push or fold.

### 3. One-Card Poker

A standard deck of 52 playing cards is used. The object is to offer a variety of wagering options based on the best five-card poker hand from a total of seven cards. Six of these cards will come by way of a community board. From these six, four cards must be used to count towards the best five-card poker hand.

To complete the best five-card poker hand, one card from the thirteen different value cards will be used to determine the best five-card hand. The thirteen cards are Ace, King. Queen, Jack, Ten, Nine, Eight, Seven, Six, Five, Four, Three and a Deuce. Each of these thirteen cards (known as the wagering cards) will represent all four suites of Hearts, Diamonds, Spades and Clubs.

Therefore, irrespective of what the community board may be, one of the above named cards, along with four cards from the community flop, must be used to determine the best possible five-card poker hand.

For example, the community flop is made from the following six cards, 2, 3, 4, 5, 6, and 7. In this case, the best card from the thirteen wagering cards would be an 8, making an 8-high straight comprising of 4, 5, 6, 7, and 8.

In any instance when the community flop contains four or more cards of the same suit, the Ace (from the wagering cards), will be the card that completes the best five-card poker hand.

In the above example, if the 2, 3, 4, and 7, were of the same suite, then the Ace would be used to make an Ace-high flush.

Continuing with the above example, if the 2, 3, 4, 5, were of the same suit, then it would be a 6 from the wagering card that completes the best five-card poker hand by making a six-high straight flush.

Therefore, before the community board of six cards is dealt, players will wager on one or more of the thirteen wagering cards. The odds will vary for each wagering, with Ace offering the least odds and a Deuce offering the highest odds. For example, an Ace would offer odds of 8-1, while the Deuce would offer odds of 60-1. The odds for each of the thirteen wagering cards will be determined by the final math.

Other Wagering Options

1. Six card poker: A pay table will be used to offer a variety of odds and wagers.

2. Seven card poker: A pay table will be used to offer a variety of odds and wagers. The wagering card may or may not be included.

3. Exacta wagers: These will offer a variety of odds to predict the best two hands in correct order. For example, Ace-King exacta will require the Ace-wagering card to be the best card followed by the King. As an example, the community board contains the following six cards: 2, 3, 6, 7, A, K. In the above case, the Ace from the wagering cards would be used to form the winning hand, followed by the King as the next best hand. Even if four of the above cards are of the same suit, the exacta wager will win.

4. A Trifecta (the best three hands) will require Ace, King and Queen to form the best three hands in that order. For example, if the community board contains the 2, 3, 6, A, K, and Q, the Trifecta wager would win.

The odds on all wagers will be determined by the final math.

### 4. One-Card-Poker for Player Versus Player for Both Cash Games and Tournaments

There are many possible versions available to this concept. One is for players to be dealt two of the wagering cards, in which any of the two will be used to create the best five-card poker hand in connection with four of the six community cards.

It is also possible to deal players more than two wagering cards to create the same game. With thirteen wagering cards, however, it limits the number of players on each table. For example, if players are dealt two wagering cards, the most the game could accommodate is six players to a table. If players are dealt three wagering cards, this can accommodate four players. If players are dealt four wagering cards, the game can accommodate three players.

As it is best to include the possibility for players to bluff, the best format may see players being dealt two wagering cards but limiting the number of players to four. In effect, eight wagering cards from thirteen would be in play, leaving five wagering hands not in play. This would mean that a player could succeed with a bluff five times from thirteen attempts. However, bluffing is very much dependent on the action of players in the hand.

With players being dealt three wagering cards, it would almost be impossible to bluff if four players are seated at the table and all four are involved in the hand. It would, therefore, seem that three wagering cards would be better suited to restricting each table to three players.

By removing wagering cards and using a standard deck of cards, the game could accommodate nine or even ten players per table. There is also immense flexibility in how many cards each player is dealt before the community board of six cards is dealt. In effect, as long as players only use one card from their hand and four from the community board, the game format remains the same. The number of cards dealt to each player can range from 2, 3, 4, 5, or 6 more cards. Irrespective, a round of wagering would take place before any community cards are dealt.

After wagering, four community cards are then dealt face up (knows as the “flop”). Then follows another round of betting before a fifth community card is dealt face up. A further round of betting can take place before the sixth and final community card is dealt face up. Then follows a last round of betting.

In this format, the number of cards dealt to each player determines the action generated. The more starting cards dealt to each player, the more likely that each hand will have multi-way action pre-flop. That may decrease after the flop, as in normal poker, but strategy is extremely simple to apply.

In order to create even further action pre-flop and post-flop, the number of community cards can be increased. For example, seven community cards can be dealt with five on the flop, one on the turn, and a final card on the river.

In some embodiments, if the number of community cards is increased, so is the number of community cards on the flop. If eight cards are dealt, the sixth card will be dealt on the community board and so forth.

One-Card Poker would differ dramatically from standard forms of poker. Its simple strategy would appeal to those of limited skill or those wishing to see more fun and enjoyment at the poker table. Very importantly, it will dramatically reduce the possibility of the best hand losing too often. Overall, a fun variation for poker players of all skills.

What is important to note is that players dealt pairs in their starting hands would be advised not to play the hand as pairs restrict options dramatically. Players may, therefore, tend to see fewer flops. In order to eradicate this, the RNG (Random Number Generator), can be programmed to avoid dealing pairs to players. It could still be random dealing, but will ensure more players entering a pot. This is perhaps important as action after the flop will tend to be limited to two or perhaps three players at most. By eradicating the possibility of players being dealt pairs in their starting hands, more action is created.

The aim behind One-Card-Poker is to address the need from online poker operations to offer a poker variation that appeals to the recreational player as opposed to the professional player and, just as importantly, to offer a variation that can level the playing field and reduce bankroll variance. The above-mentioned formats do this by limiting the action and skill requirements. Furthermore, there is the flexibility to also add further versions.

One-Card Poker+Pairs

Irrespective of how many cards are dealt to each player, any pairs within the hand will be very much disadvantages. As mentioned above, one possible solution is for the Random Number Generator to exclude pairs being dealt to a player.

One-Card Poker possesses many aspects that players will embrace. The greatest factor is how the format dramatically reduces the possibility of the best losing. This is paramount to creating a structure where strategy and mathematical probabilities rule, not luck. For example, many hands of poker are based on 50-50 chances, 60-40 chances, and 70-30 chances. This format will reduce those odds to 80-20 and 90-10. In effect, the best hand will win more often.

The format also creates many situations in which two or more players share the same winning hand. In some cases, if there are more community cards to be dealt, each player may have between 0% and 20% of improving to a better. Irrespective, the format creates a much friendlier format of poker and also reduces the skill requirements.

### 5. Oops Poker

Oops Poker is a format that allows poker players an opportunity to forfeit a percentage of chips when all-in in any specific hand during either a tournament or cash game. Therefore, the object of Oops Poker is to offer another option in how poker is played.

All current poker formats ensure that luck plays a major role in certain hands and at crucial times. For example, in Texas Holdem, the two biggest hands are two Aces versus two Kings. In this scenario, one of the two players will be extremely unlucky and the other extremely lucky. More specifically, if the two players are all in before other cards are dealt to complete the hands, the two Aces are very strong favored with approximately 83% probability of winning. In effect, it would be down to luck and the percentages. Irrespective, luck has played its part by two players having the best two possible hands in a showdown.

The Oops option would, therefore, come into play by offering the player with the worst odds of winning an opportunity to forfeit a percentage of his or her stack. The forfeit percentage could be flexible and work on a sliding scale, whereas the percentages of winning can be used as a guideline. In the above scenario, if the player holding a pair of Kings takes the Oops option, he would forfeit 83% of the chips committed into the hand.

However, that may be deemed too high a percentage and would defeat the object of reducing the luck factor in poker. Another option is to offer a set percentage (for example, 50%) to be forfeited when a player chooses the Oops option.

Although Oops is seen as primarily an option for when two players are all-in with more cards to be dealt to complete the hand, it is possible to offer the option when there are multi-way all-ins.

6. Bounty Frenzy

Bounty Frenzies are poker tournaments in which the entire entry fee (or a large percentage) goes towards a bounty on each player. There are a variety of options that need to be explored in order to perfect Bounty Frenzy. One option is to allow players to leave a tournament after gaining a minimum number of bounties (for example, five) before they are allowed to leave the event. This number could be adjusted in accordance to number of entries. For example, 5 for up to 100 entries, 6 for between 101 and 150, and 7 for over 150.

As the tournament progresses, many interesting scenarios may be presented. When a player wins a bounty by busting another player, the bounty value of the winner increases. This format continues all the way to the completion of the tournament.

It may require experimentation to determine how a tournament will conclude. One option is to have a time limit with a fats structure.

### 7. Poker Side-Bet (PSB)

PSB uses the points value of a standard deck of playing cards to create a variety of wagers. For example, cards ranging from Deuce to a Ten will be worth their face value of two points through to ten points. All face cards will also count ten. However, depending on rules, face cards may be allocated a higher scoring value. For example, Jacks may be worth eleven points, Queens may be worth twelve points, and Kings may be worth thirteen points.

By using this points scoring system and a community flop containing three cards, the points total is used to create optional side bets. Players will be offered the option to wager on three separate points.

1. Group One—low points score: The minimum points score possible in this group is three (three Aces). The range of points in this group is dependent on the math and may range between three and nine points. This point's number may be increased or reduced.

2. Group Two—high points score: The highest score in this group is 33 (three Aces).

3. Group Three—middle points group or “field bet”: This group will feature a section of points that are not included in either the low or high groups. This number is also dependent on math, but there will a selection of points that will not be available in any of three groups. This is seen as the ‘house” points score, and the range will depend on the required house edge.

The object is to create wagering options that offer both short and long odds. It is a simple matter of reducing or increasing the points requirement for each group.

In an example for low group, three points will pay 80:1. Four points will pay 66:1. Five points will pay 30:1. Six points will pay 10:1. Seven points will pay 2:1. Eight or nine points will pay 1:1.

The high group will have similar payouts. Three aces on the flop will mean that both the high and low group will pay out.

The middle group of point scores will obviously be more common and, as such, will pay shorts odds. This is again dependent on the math.

Optional winning may be included in one or more of three groups. For example, a flop containing three cards of the same suit or of the same value.

### 8. Hi Lo Points Poker

The object of the game is to accumulate a points score by using all three cards from the community flop. In order to win, the points score must fall within two groups, one with a low points score and the other with a high points score.

By using the same points value, the community flop of three cards creates a fast-paced and exciting slot game that can also utilize the multi-play slot market. Players will have the option to hold one, two, or all three cards. In very rare circumstances, players may need to decline to keep any of the three cards.

The pay table and the number of points required will be dependent on the math. The odds will vary dramatically with the longer odds being on the lowest or highest score. In this case, three Aces will count as lowest (3 points) or highest (33 points). In effect, the jackpot hand would be three Aces.

Based on the math, it is expected that each group may have between five and seven winning points score. These will pay from a minimum of one credit. The max pay out will vary.

In one embodiment, four cards will be dealt instead of three, and players must hold at least two of the four cards to create a points score. The pay table may vary from version to version.

In another embodiment, five cards will be dealt, and players must hold at least two of the five cards to create a points score. Again, the pay table may vary from the first two versions.

### 9. Points Poker

Points Poker is simply replacing poker hands with points by using the face value of standard playing cards. The object is to create a fun and simple game that brings down the barriers in terms of the skill required.

Points Poker is a split game in which 50% is paid to the hand closest to a points total of forty-one and the other 50% paid to the hand closest to a points score of fifty-one. The points total used to determine the winning hands may be or lower or higher than those stated.

Each card is counted as face value with Aces counting as either one or eleven and all face cards counting as ten. The game is played in the exact same format as a standard game of Texas Holdem poker. Players are each dealt two cards face down and a round of betting takes place.

A flop of three community cards is then dealt and another round of betting takes place. A fourth card (the turn) is then dealt and another round of betting takes place. A fifth card (the river) is then dealt and another round of betting takes place.

Players must use the points value of both of their two down cards and add that score to the points value on the cards dealt on the community board of five cards. It is important to note that, in some embodiments, the points added from the community board must be in sequence until the player has exceeded the points requirement.

A player has been dealt a points score of 20 and the community flop of three cards show the value of nine, nine, four. The player's total score will therefore be 38 (using his twenty and the first two nines on the flop). The four does not come into play at this stage because the target of forty-one points has been exceeded. However, the next target is fifty-one points and, therefore, the third card on the flop (four) comes into play. In effect, this gives the player a total point's score of forty-two. If the turn card value is nine or under, that value will be added to the player's score of forty-two. If the value of the card is over nine, the closest points score to fifty-two will in this case be forty-two

Using the same points value of cards and a community flop containing three cards, the points total is used to create optional side bets. Players will be offered the option to wager on three separate points.

1. Group One—low points score: The minimum points score possible in this group is three (three Aces). The range of points in this group is dependent of the math and may range between three and nine points. This point's number may be increased or reduced.

2. Group Two—high points score: The highest score in this group is 33 (three Aces).

3. Group Three—middle points group or “field bet”: This group will feature a section of points that are not included in either the low or high groups. This number is also dependent on math but there will a selection of points that will not be available in any of three groups. This is seen as the ‘house” points score and the range will depend on the required house edge.

Pay Tables

The object is to create wagering options that offer both short and long odds. It is a simple matter of reducing or increasing the points requirement for each group.

In an example for low group, three points will pay 80:1. Four points will pay 66:1. Five points will pay 30:1. Six points will pay 10:1. Seven points will pay 2:1. Eight or nine points will pay 1:1.

The high group will have similar payouts. Three Aces on the flop will mean that both the high and low group will pay out.

The middle group of point scores will obviously be more common and as such, will pay shorts odds. This is again dependent on the math.

### 10. Shootout—50-50

Shootout—50-50 is a tournament format in which 50% of the players on one table able advance to the next round. This is applies to tables of 4, 6, 8 or 10 players. There are several benefits:

1. No breaking of tables.

2. No moving players.

3. No hand-for-hand.

4. Reduces slow play.

5. By seeding players after the first round (based on chip stacks), it ensures that chip stacks will be more evenly spread throughout an event. This will prove paramount in eradicating the luck factor of the draw and ensuring a level playing field during the late stages of an event. For example, with the current format and with three tables remaining, it is possible that one table may contain all the top nine stacks.

6. Dramatically reduces the luck factor associated with all the above.

7. Can be played to a conclusion (when 50% of players remain) or when a pre-determined number of levels are reached. If a level limit is implemented, it is essential that slow play be eradicated by introducing a minimum number of hands to be played during the final level. If more than 50% remain after the final level, the required number of players to advance will be determined by chip stack.

8. Can dramatically increase interest in televised events as each table is played to a conclusion. It may seem far-fetched to believe that this format should be applied to any main events, but the overall benefits it offers should ensure serious consideration be given.

9. The shootout format is extremely popular with players and many feel that it is very much underused. This is despite the fact that only one player advances. With Shootout—50-50 offering an even chance of advancing rather than the standard 10-1 chance, it could well popularize shootouts further.

10. Poker is a game in which the luck factor can never be eradicated. However, the unnecessary luck associated with many aspects of a standard tournament can be eradicated. Moreover, Shootout—50-50 takes the skill factor to that of a final table. In effect, players will be able to apply the different strategy that is required for full table and for short-handed play.

11. Shootout—50-50 will dramatically reduce the workload of tournament staff.

12. The format is flexible and can be introduced for 10-handed events, 8-handed events and 6-handed events.

### 11. Fantasy Racing Odds

Points are awarded for predicting the winning odds of selected races. The following are possible returns in dollars and cents:

(a) 2.00-3.99

(b) 4.00-5.99

(c) 6.00-7.50

(d) 7.51-9.99

(e) 10.00-12.49

(f) 12.50-14.99

(g) 15.00-17.49

(h) 18.50-20.99

(i) 21.00-23.49

(j) 23.50-25.99

(k) 26.00-28.49

(l) 28.50-31.99

(m) 32.00-35.99

(n) 36.00. 42.99

(o) 43.00+

The above list of fifteen groups could be increased or decreased depending on requirements. Irrespective, the object would be for players to select a set of eight groups from (a) thru (o). This set of groups must be placed in preferred order based on the following rules.

Player will be given a set number of horse races (for example 10) from a number of racing tracks. The object would be for players to study these races and determine the winning returns from each race. They must then use their skill and judgment to try and calculate the most frequent odds returns. For example, if many of the races have very short odds, then (a) is likely to be a common return. If on the other hand, the races are very open with large fields, the middle groups of (d), (e), and (f) may fair better.

Each horse race will in effect ensure that the returning odds will fall within one of the groups. Points are gained for the group when it the returns match one of the odds options. However, the number of points gained will be determined by the order in which the set of eights groups are chosen. For example: a player can choose these eights groups and placed them in the following order: (b), (d), (a), (f), (g), (h), (o), (f). The scoring for this player will be as follows. Each time a return is matched to (b), that player scores 20 points. When it is matched to (d), the points scored are 18. (a) scores 16 points and so forth down to 6 points for (f). Therefore the order of preference is paramount to the points score.

Various bonus points could be awarded. For example—100 extra points if all 8 selections score points. Double points for the last race, etc. All points will count double for the first group chosen by the player. In the above example, all points gained by group (B) would count double.

### 12. Fantasy Single (FS)

This is based on the outcome of a one specific race. Players are required to select a group of numbers and place them in order of preference. These will correspond to actual horses in the selected race. In this example, the selected race consists of 12 horses, numbered 1 through 12. Players will therefore need to select 12 numbers and place them in an order that they believe all 12 horses will finish the race. In this case, there will be 12 scoring factors—A through K.

In this example, a player has selected all 12 in order—with number 1 being first choice and 12 being 12^{th} choice. Therefore, number 1 would be placed in A, 2 in B, 3 in C, etc.

In effect, players will score points with each horse, irrespective of final placing. What will determine the winners, is the order of the their selections. Scoring as follows for 1^{st} thru 12^{th} in the selected race: 15, 13, 11, 10, 9, 8, 7, 6, 5, 4, 3, 2. These points are multiplied by the following scoring system: A×12, B×11, C×10, D×9, E×8, F×7, G×6, H×5, I×4, J×3, K×2.

In this example, A represents horse number 1, B represents horse number 2, C represents horse number 3 etc., down to K representing horse number 12. As an example, the race results was as follows: 12, 3, 1, 5, 6, 7, 4, 9, 10, 8, 11, 2.

Our player therefore scores as follows:

(A), (horse number 1) finished in 3^{rd} place. Third place scores 11 points. This is multiplied by the X factor of A (12). Therefore, 11×12=132

(B) (Horse number 2), finished in 10th place. Tenth place scores 4 points. B has an X factor 11. The final score therefore is 4×11=44 points.

### 13. Fantasy Races (FR)

There are a few options in how multiple races can be incorporated into the fantasy format. And although this may not offer instant payouts, it may take as little as thirty minutes to conclude a game. Perhaps more importantly, it will give players immense fun and excitement. Points scoring will again determine winners.

The format is very simple. It simply requires entrants to select 6 numbers (this number is flexible and more or less numbers can apply), from a list of numbers corresponding with the numbers of horses from selected races. For example, if five horse races are selected to feature in this mini tournament (MT), then the list should include the highest number that applies to an actual horse. In effect, four races may have a max of ten runners (giving us a list of 1 through 10). If the fifth race has fifteen runners—then the list will contain numbers 1 through 15.

Therefore, every horse running within the selected races will have a number that corresponds to that horse. This rule applies to ALL the selected races in the MT. If a player therefore chooses number 2, the 2 horse in each of the five races may score points for that player.

As with the first format, selected numbers are required to be placed in order of preference as this order determines the number of points awarded. In effect, a scoring format similar to the single game.

In order to try and present this as a skill game, certain information on the races must be offered. In this case, it may be as simple as having the list of numbers (15), highlight the total number that each list number corresponds to a horse. In other words, we have five races with each race having the following number of runners:

Race 1: 7 runners

Race 2: 8 runners

Race 3: 9 runners

Race 4: 10 runners.

Race 5: 15 runners

If a player selects 6 numbers from 1 through 7, that player will have 6 horses that can score points in ALL races. If a player's selection includes a number higher than 7 (for example, 9), then that player will have horses representing him in races of less than nine. Player's will therefore need to apply skill in every aspect of this game. It does not however, prohibit them from using the quick pick option.

The aim here is to present a game that will generate fun and excitement, while at the same time, trying to adhere to the USA legal requirements.

### 14. Cash Poker Tournaments

By setting a time limit, cash tournaments are seen as speed tournaments without reducing the skill factor. They also offer flexibility in terms of how they are presented to players. One option is to have four thirty-minute levels.

A percentage of the original buy-in can be set aside to form four prize pools of equal value. Each of these prize pools will be used to create 4× Stack Races. These could be awarded to the chip-leader at the end of each level. The prize would be paid direct into the player's balance and not added to his chip stack.

Tournament starting chips will be cash for cash. For example, if the buy-in is $150, $40 from the $150 buy-in will be the amount set aside for the four prize pools. If 100 players enter the event, there will be 4×$1000 prizes. Using the same example, players would therefore begin with a starting stack of $110.

Starting blinds will be around 400 to 5,000 big blinds. Subsequent blind increases, if any, could be kept small as the object is to give player ample play. In the above example, players would begin with $110 in chips. Therefore, the blinds could begin at 10-20 cents. These could rise after each level. For example, 20-40 cents, 30-60 cents and 40-80 cents.

A progressive jackpot could be offered for any player collecting all four $1000 prizes in a single event. Therefore, a $150 buy-in would be broken down into the following sections. $100 would be the starting stack. $40 would be set aside for the 4×$1000 chip-leader prizes. $10 would be added to the running jackpot prize pool, with perhaps 80% of this paid to any player winning all 4×$1000 prizes and 20% paid to any player winning three of the 4×$1000 chip-leader races.

The format is flexible and can be amended in a variety of ways. The most obvious of these is how much is taken from the original buy-in for the four chip-races and for the jackpot. Also, rather than have just a single prize for the four chip races as in the example used, three prizes could be offered. Example: $600, $250 and $150.

At the end of the four levels, players will leave the game with whatever chips they have remaining.

Another option is to simply create a Cash Tournament by which 50% of the buy-in is used to create a standard tournament with a standard prize pool payout. Using the same example of a $150-buy-in and 100 players; $75 will go towards the prize pool. This will mean that players will start with $75 in chips for the Cash Tournament. Blinds could begin at 10 cents 20 cents. Play will continue for the four levels. If ten prizes are awarded for the Cash Tournament, the top ten stacks will be paid according to position. For example, 1st place will be awarded to the chip leader and so forth down to tenth place going to player tenth in chips at the end of the four levels.

Another option is to create a Cash Tournament with a combination of the above two options. For example, $75 from the $150 will be used to not only create a Cash Tournament as above, but also create 4× Chip Races. Example, $20 of the $75 will be used for the 4× Chip Races while $55 will be used for the actual Cash Tournament.

Another option is to base the four payouts based on the number of hands won and not the size of the players stacks.

### 15. Fantasy Roulette and Bingo

The object is to create a fantasy format based on two of the most popular games of roulette and bingo and as such, offer a casino to generate a form of rake.

For fantasy roulette, players will pay an entry fee and select a group of numbers that correspond with the numbers on a roulette wheel. This will range from either a single or double zero up to or including number thirty-six. This group may consist of one or more numbers dependent on the final rules. In this example, the group will consist of ten numbers. This group on numbers will then gain points each time one of these numbers has been called on either a live roulette or through an random number generator (RNG).

All entry fees minus any commission for the house would be used to form a prize pool in a tournament. A game will consist of a predetermined number is spins—for example 20 spins. All points are then calculated to form a league in which prizes are distributed according to league position. Tournaments sizes may vary and offer different entry fees similar to poker tournaments.

The same format can be applied to bingo. In this, players would choose a group of numbers ranging from one to ninety,

### Technical Components

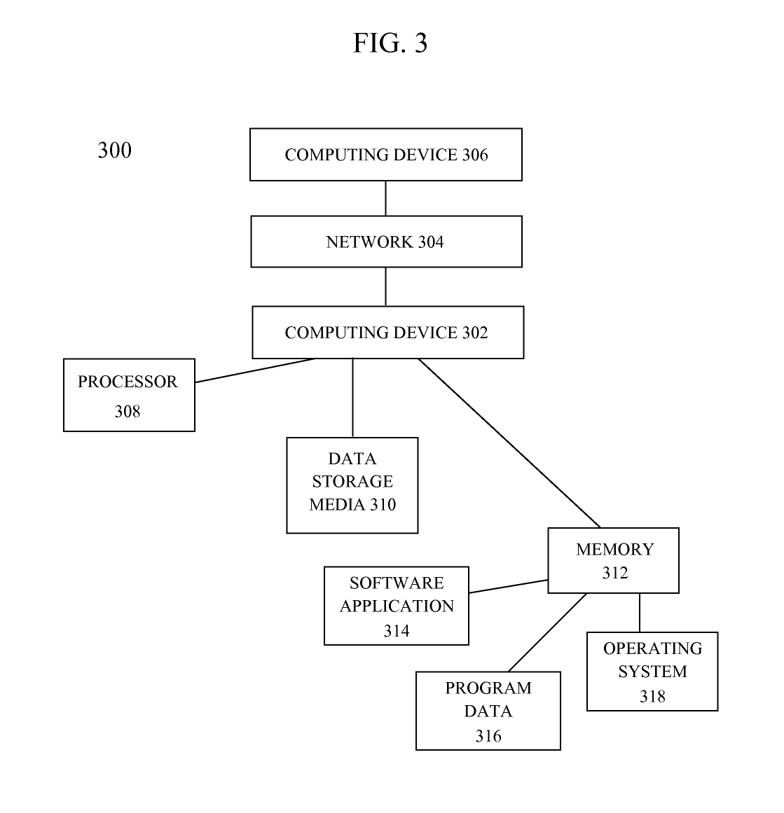

In some embodiments, the system described herein uses a computing system to carry out the various functions described herein. FIG. 3 is a schematic block diagram of an example computing system 300. The example computing system 300 includes at least one computing device 302. In some embodiments the computing system 300 further includes a communication network 304 and one or more additional computing devices 306 (such as a server).

The computing device 302 can be, for example, located in place of business or can be a computing device 302 located in a user's home or office. In some embodiments, computing device 302 is a mobile device. The computing device 302 can be a stand-alone computing device or a networked computing device that communicates with one or more other computing devices 306 across a network 304. The additional computing device(s) 306 can be, for example, located remotely from the first computing device 302, but configured for data communication with the first computing device 302 across a network 304.

In some examples, the computing devices 302 and 306 include at least one processor or processing unit 308 and system memory 312. The processor 308 is a device configured to process a set of instructions. In some embodiments, system memory 312 may be a component of processor 308; in other embodiments system memory 312 is separate from the processor 308. Depending on the exact configuration and type of computing device, the system memory 312 may be volatile (such as RAM), non-volatile (such as ROM, flash memory, etc.) or some combination of the two. System memory 312 typically includes an operating system 318 suitable for controlling the operation of the computing device 302, such as the WINDOWS® operating systems or the OS X operating system, or a server, such as Windows SharePoint Server, also from Microsoft Corporation, or such as a Mac Mini with OS X. The system memory 312 may also include one or more software applications 314 and may include program data 316.

The computing device 302 may have additional features or functionality. For example, the computing device 302 may also include additional data storage devices 310 (removable and/or non-removable) such as, for example, magnetic disks, optical disks, or tape. Computer storage media 310 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media 310 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 302. An example of computer storage media 310 is non-transitory media.

In some examples, one or more of the computing devices 302 and 306 can be located in a user's home or place of business. In other examples, the computing device 302 can be a personal computing device that is networked to allow the user to access and utilize the system disclosed herein from a remote location, such as in a user's home, office or other location. In some embodiments, the computing device 302 is a smart phone tablet, laptop computer, personal digital assistant, or other mobile device. In some embodiments, system operations and functions are stored as data instructions for a smart phone application. A network 304 facilitates communication between the computing device 302 and one or more servers, such as an additional computing device 306, that hosts the system. The network 304 may be a wide variety of different types of electronic communication networks. For example, the network 304 may be a wide-area network, such as the Internet, a local-area network, a metropolitan-area network, or another type of electronic communication network. The network 304 may include wired and/or wireless data links. A variety of communications protocols may be used in the network 304 including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 306 is a Web server. In this example, the first computing device 302 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor 308 of the one or more computing devices 302 or 306, the instructions cause the processor 308 to perform one or more of the operations or methods disclosed herein.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A card deck of 48 cards, wherein the card deck is comprised of two suits and 8 sets of six cards that are numbered ace, two, three, four, five, and six.

2. A method of playing a card game with players and a dealer in a computing system comprising at least one server to host the card game and at least one computing device communicably coupled to the at least one server through a communication network, the method comprising:
using a card deck of 48 cards, wherein the card deck is comprised of two suits and 8 sets of six cards that are numbered ace, two, three, four, five, and six;
dealing to each player, in turn, six cards through at least one server;
allowing each player to organize the six cards into three groups of two cards;
receiving two cards from each player per turn;
adding together the numbers on each of the two cards for each player;
allowing each player to move a game piece a number of spaces on a game board, wherein the number of spaces equates to the additive number from each player's corresponding two cards; and
determining whether a player has won through at least one server by understanding when one player has moved all of the player's pieces to a finishing position on the board.

3. A method of playing a card game with players and dealer in a computing system comprising at least one server to host the card game and at least one computing device communicably coupled to the at least one server through a communication network, the method comprising:
using a card deck of 48 cards, wherein the card deck is comprised of two suits and 8 sets of six cards that are numbered ace, two, three, four, five, and six;
dealing to each player, in turn, two cards through at least one server;
accepting a first round of betting after the two cards are dealt;
dealing two community cards;
accepting a second round of betting after the two community cards are dealt;
dealing a third community card;
accepting a third round of betting after the third community card is dealt;
dealing a fourth community card;
accepting a fourth round of betting after the fourth community card is dealt;
allowing each player to use one of the two cards in their hand to combine with the four community cards;
determining whether a player has won though the at least one server by understanding which player has the best five-card poker hand.
